(19) United States
(12) Patent Application Publication
(10) Pub. No.: US 2022/0314377 A1
(43) Pub. Date: Oct. 6, 2022

(54) HIGH-STRENGTH STEEL SHEET BLANK HAVING DECARBURIZED OUTER LAYERS

(71) Applicant: GM GLOBAL TECHNOLOGY OPERATIONS LLC, Detroit, MI (US)

(72) Inventors: MingFeng Shi, West Bloomfield, MI (US); Adam D. Hodges, Warren, MI (US); Carlos E. Prado, Ann Arbor, MI (US); Jason J. Coryell, Rochester Hills, MI (US)

(73) Assignee: GM GLOBAL TECHNOLOGY OPERATIONS LLC, Detroit, MI (US)

(21) Appl. No.: 17/223,373

(22) Filed: Apr. 6, 2021

(51) Int. Cl. B23K 35/02; C22C 38/00; B23K 35/30; C21D 9/00

(52) U.S. Cl. CPC B23K 35/0238; C22C 38/00; B23K 35/3053; C21D 9/00; C21D 2211/002; C21D 2211/001; C21D 2211/005; C21D 2211/008; B23K 2103/04

(57) ABSTRACT

A sheet blank includes a core substrate having a generally planar shape with opposed first and second sides. The core substrate is made of high-strength steel containing at least two of ferrite, martensite, bainite, and austenite and having an ultimate tensile strength of at least 490 MPa. A respective decarburized layer of the high-strength steel is formed on each of the first and second sides of the core substrate, wherein each respective decarburized layer contains a minimum ferrite content of at least 80 volume % ferrite and has a respective thickness of 5 to 100 microns. A respective transition layer of the high-strength steel may be formed between the core substrate and each respective decarburized layer, with each transition layer having a respective inner transition layer abutting the core substrate and a respective outer transition layer abutting the respective decarburized layer.

### INTRODUCTION

This disclosure relates generally to sheet blanks made of high-strength steel.

Some steels—particularly high-strength steels—lack sufficient local formability due to the differences in strength among the various microstructural phases found in the steel. This lack of sufficient local formability may detrimentally affect forming processes such as flanging, bending and edge stretching. Furthermore, the use of high alloy contents in high-strength steels also causes surface oxidation, which results in a high electrical resistivity on the surface of these steels, thereby impeding their weldability during assembly operations.

### SUMMARY

According to one embodiment, a sheet blank includes a core substrate having a generally planar shape with opposed first and second sides, the core substrate being made of high-strength steel containing at least two of ferrite, martensite, bainite, and austenite and having an ultimate tensile strength of at least 490 MPa, and a respective decarburized layer of the high-strength steel formed on each of the first and second sides of the core substrate, wherein each respective decarburized layer contains a minimum ferrite content of at least 80 volume % ferrite and has a respective thickness of 5 to 100 microns.

In this embodiment, the high-strength steel may have an ultimate tensile strength of at least 550 MPa. The high-strength steel of the core substrate may contain at least 95 volume % martensite, wherein the high-strength steel may have an ultimate tensile strength of at least 900 MPa, and/or wherein the high-strength steel of the core substrate may contain no more than 5 volume % of ferrite, bainite, austenite, or a combination of two or more of ferrite, bainite, and austenite.

A respective transition layer of the high-strength steel may be formed between the core substrate and each respective decarburized layer, with each transition layer having a respective inner transition layer abutting the core substrate and a respective outer transition layer abutting the respective decarburized layer, wherein the volume % ferrite in each respective transition layer varies from 0 to 70 volume % in the respective inner transition layer up to the minimum ferrite content in the respective outer transition layer. Alternatively, a respective transition layer of the high-strength steel may be formed between the core substrate and each respective decarburized layer, with each transition layer having a respective inner transition layer in contact with the core substrate and a respective outer transition layer in contact with the respective decarburized layer, wherein each respective inner transition layer contains 0 to 70 volume % ferrite and each respective outer transition layer contains at least the minimum ferrite content.

The high-strength steel of the core substrate may contain: (i) martensite and ferrite, (ii) martensite, ferrite and bainite, (iii) martensite, ferrite and austenite, or (iv) martensite, ferrite and retained austenite. Optionally, the high-strength steel of the core substrate may contain less than 80 volume % ferrite. Each respective decarburized layer may contain at least 85 volume % ferrite, or at least 90 volume % ferrite.

According to another embodiment, a sheet blank includes: a core substrate having a generally planar shape with opposed first and second sides, the core substrate being made of high-strength martensitic steel containing at least 95 volume % martensite and having an ultimate tensile strength of at least 900 MPa; and a respective decarburized layer of the high-strength martensitic steel formed on each of the first and second sides of the core substrate, wherein each respective decarburized layer contains at least 80 volume % ferrite and has a respective thickness of 5 to 100 microns. In this embodiment, the high-strength martensitic steel of the core substrate may contain up to 5 volume % of ferrite, bainite, austenite, or a combination of two or more of ferrite, bainite, and austenite.

According to yet another embodiment, a sheet blank includes: (i) a core substrate having a generally planar shape with opposed first and second sides, the core substrate being made of high-strength martensitic steel containing at least 95 volume % martensite and containing up to 5 volume % of ferrite, bainite, austenite, or a combination of two or more of ferrite, bainite, and austenite and having an ultimate tensile strength of at least 900 MPa; and (ii) a respective decarburized layer of the high-strength martensitic steel formed on each of the first and second sides of the core substrate, wherein each respective decarburized layer contains a minimum ferrite content of at least 80 volume % ferrite and has a respective thickness of 5 to 100 microns.

In this embodiment, a respective transition layer of the high-strength martensitic steel may be formed between the core substrate and each respective decarburized layer, wherein the volume % ferrite in each respective transition layer varies from 0 to 5 volume % in a respective inner transition layer thereof that is disposed in contact with the core substrate up to the minimum ferrite content in a respective outer transition layer thereof that is disposed in contact with the respective decarburized layer. The high-strength martensitic steel of the core substrate may contain less than 5 volume % ferrite, and each respective decarburized layer may contain at least 85 volume % ferrite.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic cross-sectional view of a sheet blank having a core substrate and decarburized outer layers.

FIG. 2 is a schematic cross-sectional view of a sheet blank having a core substrate, decarburized outer layers and transition layers.

FIG. 3 is a schematic perspective view of a flat core substrate.

FIG. 4 is a schematic front end view of the flat core substrate of FIG. 3.

FIG. 5 is a schematic perspective view of a curved core substrate.

FIG. 6 is a schematic front end view of the curved core substrate of FIG. 5.

FIG. 7 is a block diagram of possible high-strength steel components.

FIG. 8 is an enlarged schematic cross-sectional view of the dashed rectangle portion of FIG. 2, illustrating the directions of increasing volume % ferrite and hardness.

FIG. 9 is a graph of hardness vs. distance from the surface for a decarburized layer, a transition layer and the core substrate.

FIG. 10 is an enlarged schematic cross-sectional view of the dashed rectangle portion of FIG. 2, showing inner, central and outer transition layers.

### DETAILED DESCRIPTION

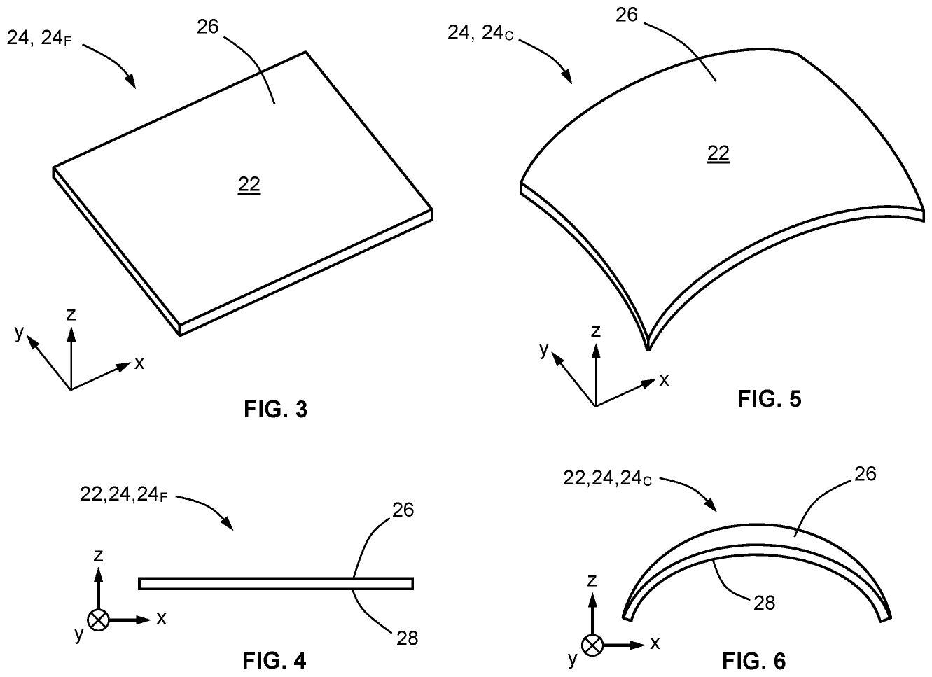

Referring now to the drawings, wherein like numerals indicate like parts in the several views, a high-strength steel sheet blank 20 is shown and described herein. Note that certain reference numerals in the drawings and description have subscripts, such as the flat planar shape 24F and the curved planar shape 24c of FIGS. 3-6. Subscripts are used in the drawings and in the present description to refer to individual elements or embodiments (such as the aforementioned planar shapes), while the use of reference numerals without subscripts may refer to the collective group of such elements or embodiments, and/or to a singular but generic one of such elements or embodiments. Thus, reference numeral 24F refers to a specific planar shape, while reference numeral 24 (without the subscript) may refer to all planar shapes, the group of planar shapes, or a singular but generic planar shape (i.e., any planar shape).

As more fully described below, the sheet blank 20 of the present disclosure provides a thin decarburization layer 30 on the outer surfaces 26, 28 of a core substrate 22 made of high-strength steel in sheet form. The high-strength steel may be an uncoated and/or martensitic steel, including so-called “advanced high-strength steels” (AHSS), “dual phase steels” (e.g., containing martensite and ferrite), “ultra-high-strength steels”, “multi-phase steels”, “complex phase steels”, “quench and partition (QP) steels”, “Transformation Induced Plasticity (TRIP) steels” and “Generation 3 steels”. (As used here, an “uncoated” steel is one having no coatings, platings or other metallizations added to the outer surface thereof.) These decarburized layers 30 may be formed on the outer surfaces 26, 28 of the core substrate 22 so as to provide a thin outer surface layer composed of a soft ferritic microstructure, while leaving the microstructure of the core substrate 22 unchanged. This thin ferritic outer (decarburized) layer 30 aids in localized forming and bending operations, due to the reduced efforts needed to form or bend this softer surface layer. Additionally, the decarburized outer surface layer 30 reduces surface oxidation, which reduces the surface's electrical resistivity and improves weldability, as well as reducing or eliminating the need for pickling.

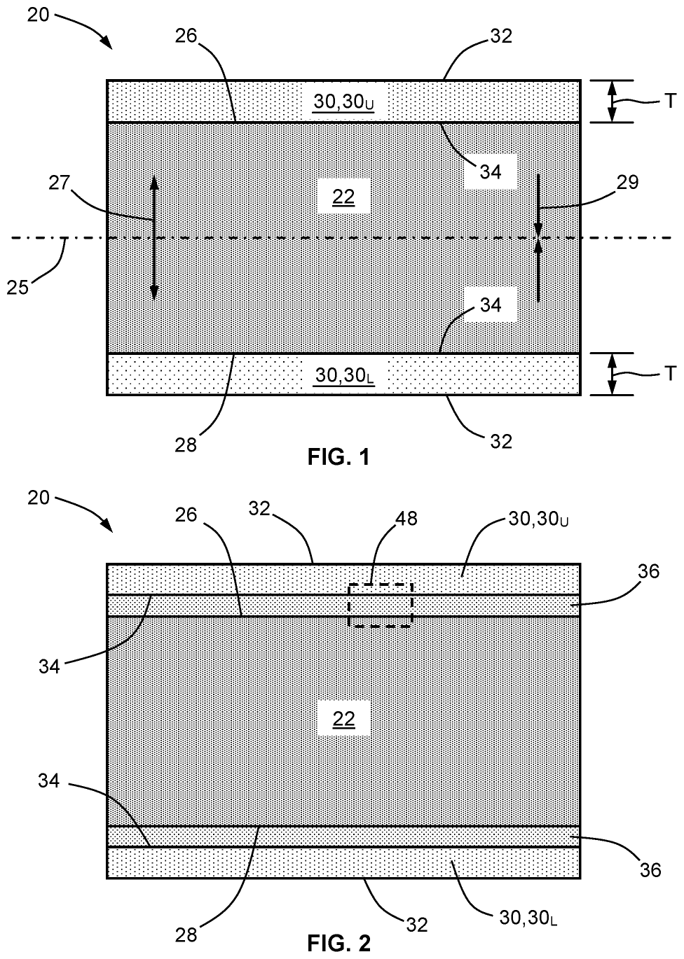

FIGS. 1-2 show schematic cross-sectional views of two different embodiments or configurations of the sheet blank 20, and FIGS. 3-6 show schematic cross-sectional views and front end views of two different geometric configurations of a core substrate 22 used to make the sheet blank 20. According to one embodiment, a sheet blank 20 includes a core substrate 22 having a generally planar shape 24 (e.g., a sheet-like shape) with opposed first and second sides 26, 28. The core substrate 22 may have a generally flat planar shape 24F as illustrated in FIGS. 3-4, or a generally curved planar shape 24c as illustrated in FIGS. 5-6. Note that in the generally curved planar shape 24c of FIGS. 5-6, the core substrate 22 is curved about the x-axis and the y-axis, which imparts a crown or rounded apex to the top of the core substrate 22. It should be apparent that whatever planar shape 24 is used for the core substrate 22, this same planar shape 24 is imparted to the overall sheet blank 20 as well.

The core substrate 22 is made of high-strength steel containing at least two of ferrite, martensite, bainite, and austenite (including retained austenite) and having an ultimate tensile strength of at least 490 MPa. The sheet blank 20 also includes a respective decarburized layer 30 of the high-strength steel formed on each of the first and second sides 26, 28 of the core substrate 22, wherein each respective decarburized layer 30 contains a minimum ferrite content of at least 80 volume % ferrite and has a respective thickness T of 5 to 100 microns. Thus, an upper decarburized layer 30_{U} may be formed on the upper surface or first side 26 of the core substrate 22, and a lower decarburized layer 30_{L} may be formed on the lower surface or second side 28 of the core substrate 22, with each of the upper and lower decarburized layers 30_{U}, 30_{L} having a respective outer surface 32 and a respective opposed inner surface 34. As illustrated in FIG. 1, the core substrate 22 may have a neutral axis 25, thereby defining an outer or outward direction 27 pointing away from the neutral axis 25 and toward each of the first and second surfaces 26, 28, and also defining an inner or inward direction 29 pointing toward the neutral axis 25 and away from each of the first and second surfaces 26, 28.

In another embodiment or configuration, the high-strength steel may optionally have a higher ultimate tensile strength, such as 550 MPa or more. Optionally, the high-strength steel of the core substrate 22 may contain at least 95 volume % martensite, with the high-strength steel having an ultimate tensile strength of at least 900 MPa. Additionally or alternatively, the high-strength steel of the core substrate 22 may contain no more than 5 volume % of ferrite, bainite, austenite, or a combination of two or more of ferrite, bainite, and austenite.

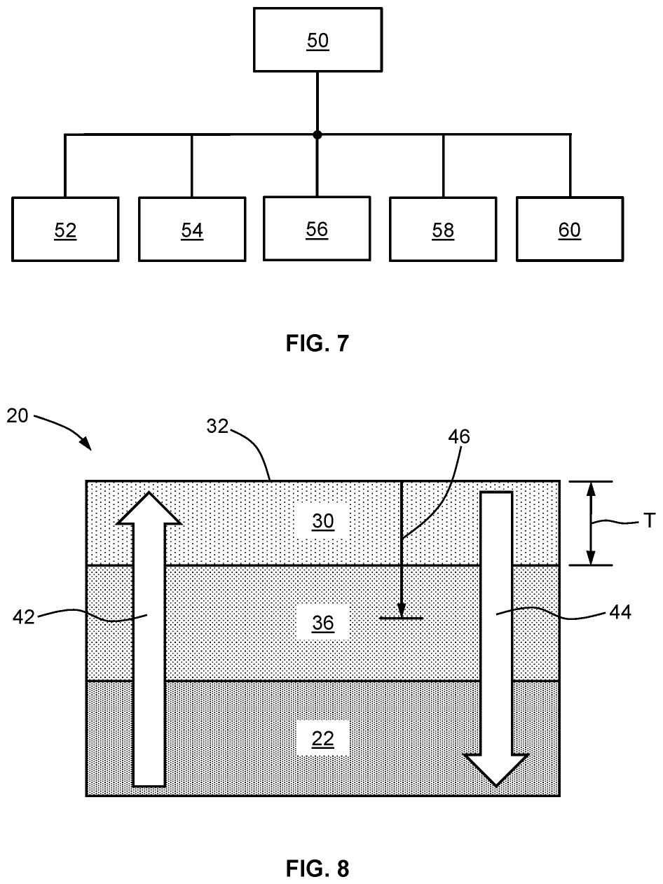

FIG. 7 shows a block diagram of possible high-strength steel components. (Note that the reference numerals used in FIG. 7 to denote the high-strength steel and its possible components are only used in FIG. 7 of the drawings, and in the present paragraph of the Detailed Description.) The high-strength steel 50 of the core substrate 22 may contain: (i) martensite 52 and ferrite 54, (ii) martensite 52, ferrite 54 and bainite 56, (iii) martensite 52, ferrite 54 and austenite 58, or (iv) martensite 52, ferrite 54 and retained austenite 60. Optionally, the high-strength steel of the core substrate 22 may contain less than 80 volume % ferrite. Each respective decarburized layer 30 may contain at least 85 volume % ferrite, or at least 90 volume % ferrite.

As shown in FIGS. 2 and 8-10, a respective transition layer 36 of the high-strength steel may be formed between the core substrate 22 and each respective decarburized layer 30, with each transition layer 36 having a respective inner transition layer 38 abutting or in contact with the core substrate 22 and a respective outer transition layer 40 abutting or in contact with the respective decarburized layer 30. (As shown in FIG. 10, an optional central transition layer 38 may be interposed between the inner and outer transition layers 38, 40.) The volume % ferrite in each respective transition layer may vary from a lower number or range, such as 0 to 70 volume %, in the respective inner transition layer 38, up to the minimum ferrite content (i.e., at least 80 volume % ferrite) in the respective outer transition layer 40. (For example, each respective inner transition layer 38 may contain 0 to 70 volume % ferrite and each respective outer transition layer 40 may contain 80 volume % ferrite or more.) It should be noted that FIGS. 1-2 and 8-10 are schematic drawings in which the core substrate 22, transition layers 36 and decarburized layers 30 appear to be separated from each other by sharp lines to denote their differing levels of volume % ferrite; however, this is merely a schematic convention, as actual sheet blanks 50 might not have such sharp and abrupt transitions in volume % ferrite, with the change in volume % ferrite being more gradual and continuous.

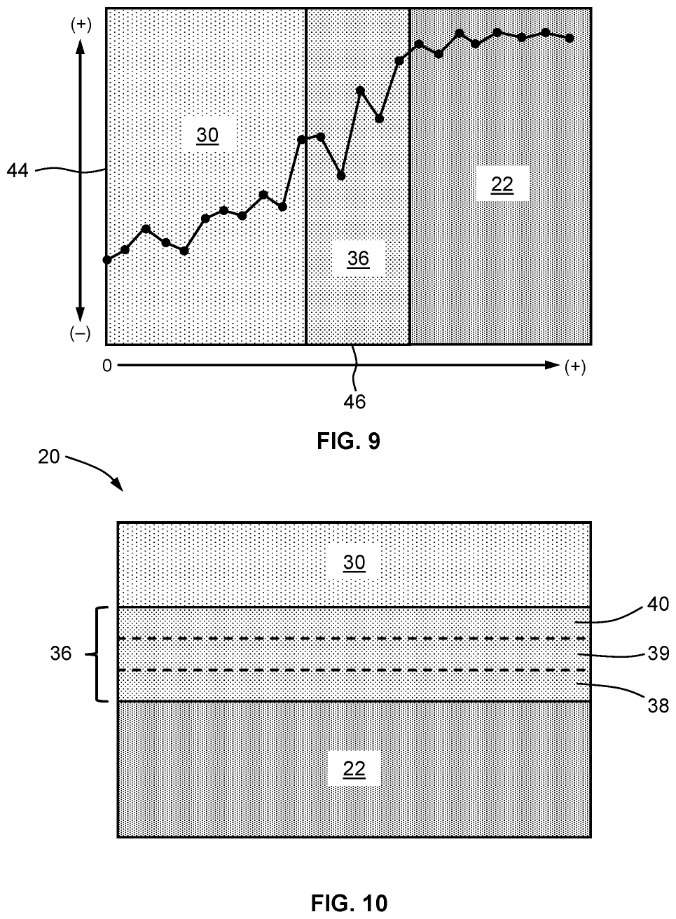

FIG. 8 shows an enlarged schematic cross-sectional view of the dashed rectangle portion 48 of FIG. 2. The upward arrow 42 indicates the direction of increasing volume % ferrite across the core substrate 22, transition layers 36 and decarburized layer 30, and the downward arrow 44 indicates the direction of increasing hardness. Thus, since ferrite is a softer microstructure than martensite and other microstructures, as the volume % ferrite increases, the hardness decreases. For example, the decarburized layer 30 contains a higher volume % ferrite than the core substrate 22, so the decarburized layer 30 is softer and more malleable, bendable and formable than the core substrate 22.

FIG. 9 shows a graph of hardness 44 (in units of Vickers hardness HV_{0.05}) vs. distance or depth 46 (in microns or micrometers μm) from the surface 32 for a decarburized layer 30, a transition layer 36 and the core substrate 22. Note that the distance 46 from the surface 32 is shown in FIG. 8, and the plot of points in FIG. 9 indicate an upward slope (i.e., a rise in hardness 44) as the distance 46 from the surface 32 increases, until the hardness 44 levels out at a given level in the core substrate 22. Thus, as the distance or depth 46 from the surface 32 increases in the decarburized layer 30 and the transition layer 36, so does the hardness 44. Contrarily, closer to the surface 32 (e.g., in each decarburized layer 30), the hardness 44 decreases, making the surface region softer and the overall sheet blank 20 more formable. (Also note that the specific data points for the hardness 44 and depth 46 of the core substrate 22, transition layer 36 and decarburized layer 30 shown in FIG. 9 are for illustration purposes only and should not be used to define or limit the scope of the appended claims.)

The decarburized outer layers 30 (and the transition layers 36) may be produced by sending the core substrate 22 of high-strength steel through a batch decarburization process or a continuous decarburization process, thereby producing the sheet blank 20 of the present disclosure. The produced sheet blank 20 may then be used to form various types of structural components, which may involve stamping, roll forming, MIG (metal inert gas) welding, spot welding, etc. The formation of the decarburized outer layers 30 serves to improve the local formability and bendability in stamping, rolling and other forming processes, as well as to improve weldability in assembly processes.

According to another embodiment, a sheet blank 20 includes: a core substrate 22 having a generally planar shape 24 with opposed first and second sides 26, 28, the core substrate 22 being made of high-strength martensitic steel containing at least 95 volume % martensite and having an ultimate tensile strength of at least 900 MPa; and a respective decarburized layer 30 of the high-strength martensitic steel formed on each of the first and second sides 26, 28 of the core substrate 22, wherein each respective decarburized layer 30 contains at least 80 volume % ferrite and has a respective thickness T of 5 to 100 microns. In this embodiment, the high-strength martensitic steel of the core substrate 22 may contain up to 5 volume % of ferrite, bainite, austenite, or a combination of two or more of ferrite, bainite, and austenite.

According to yet another embodiment, a sheet blank 20 includes: (i) a core substrate 22 having a generally planar shape 24 with opposed first and second sides 26, 28, with the core substrate 22 being made of high-strength martensitic steel containing at least 95 volume % martensite and containing up to 5 volume % of ferrite, bainite, austenite, or a combination of two or more of ferrite, bainite, and austenite and having an ultimate tensile strength of at least 900 MPa; and (ii) a respective decarburized layer 30 of the high-strength martensitic steel formed on each of the first and second sides 26, 28 of the core substrate 22, wherein each respective decarburized layer 30 contains a minimum ferrite content of at least 80 volume % ferrite and has a respective thickness T of 5 to 100 microns.

In this embodiment, a respective transition layer 36 of the high-strength martensitic steel may be formed between the core substrate 22 and each respective decarburized layer 30, wherein the volume % ferrite in each respective transition layer 36 varies from 0 to 5 volume % in a respective inner transition layer 38 thereof that is disposed in contact with the core substrate 22 up to the minimum ferrite content in a respective outer transition layer 40 thereof that is disposed in contact with the respective decarburized layer 30. The high-strength martensitic steel of the core substrate 22 may contain less than 5 volume % ferrite, and each respective decarburized layer 30 may contain at least 85 volume % ferrite.

It should be noted that some or all of the specific numbers and ranges provided herein may be illustrative and not exhaustive or excluding alternatives. Thus, other specific numbers and ranges may be used instead of or in addition to the specific numbers and ranges mentioned. As a first example, in addition to or instead of the core substrate 22 having an ultimate tensile strength of at least 490 MPa, the core substrate 22 may have an ultimate tensile strength (in MPa) of at least 500, 550, 600, 650 or any number greater than 490, including any number greater than 900. As a second example, in addition to or instead of each respective decarburized layer 30 containing a minimum ferrite content of at least 80 volume % ferrite, each respective decarburized layer 30 may contain a minimum ferrite content of 75, 76, 77, 78, 79, 81, 82, 83, 84, 85, 86, 87, 88, 89, 90, 91, 92, 93, 94 or 95 volume % ferrite, including decimal increments between these whole numbers. And as a third example, in addition to or instead of each respective decarburized layer 30 having a respective thickness T of 5 to 100 microns, each respective decarburized layer 30 may have a respective thickness T of X to Y microns, where X is any integer between 5 and 90, and Y is any integer greater than X between 10 and 150. For example, the thickness T may be 5 to 20 microns, 10 to 50 microns, 40 to 100 microns, 30 to 120 microns, 5 to 150 microns, and so forth.

The above description is intended to be illustrative, and not restrictive. While the dimensions and types of materials described herein are intended to be illustrative, they are by no means limiting and are exemplary embodiments. In the following claims, use of the terms “first”, “second”, “upper”, “lower”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “for the most part”, “to a significant extent” and/or “to a large degree”, and do not necessarily mean “perfectly”, “completely”, “strictly” or “entirely”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A sheet blank, comprising:
a core substrate having a generally planar shape with opposed first and second sides, the core substrate being made of high-strength steel containing at least two of ferrite, martensite, bainite, and austenite and having an ultimate tensile strength of at least 490 MPa; and
a respective decarburized layer of the high-strength steel formed on each of the first and second sides of the core substrate, wherein each respective decarburized layer contains a minimum ferrite content of at least 80 volume % ferrite and has a respective thickness of 5 to 100 microns.

2. A sheet blank according to claim 1, wherein the high-strength steel has an ultimate tensile strength of at least 550 MPa.

3. A sheet blank according to claim 1, wherein the high-strength steel of the core substrate contains at least 95 volume % martensite.

4. A sheet blank according to claim 3, wherein the high-strength steel has an ultimate tensile strength of at least 900 MPa.

5. A sheet blank according to claim 3, wherein the high-strength steel of the core substrate contains no more than 5 volume % of ferrite, bainite, austenite, or a combination of two or more of ferrite, bainite, and austenite.

6. A sheet blank according to claim 1, wherein a respective transition layer of the high-strength steel is formed between the core substrate and each respective decarburized layer, with each transition layer having a respective inner transition layer abutting the core substrate and a respective outer transition layer abutting the respective decarburized layer, wherein the volume % ferrite in each respective transition layer varies from 0 to 70 volume % in the respective inner transition layer up to the minimum ferrite content in the respective outer transition layer.

7. A sheet blank according to claim 1, wherein a respective transition layer of the high-strength steel is formed between the core substrate and each respective decarburized layer, with each transition layer having a respective inner transition layer in contact with the core substrate and a respective outer transition layer in contact with the respective decarburized layer, wherein each respective inner transition layer contains 0 to 70 volume % ferrite and each respective outer transition layer contains at least the minimum ferrite content.

8. A sheet blank according to claim 1, wherein the high-strength steel of the core substrate contains martensite and ferrite.

9. A sheet blank according to claim 1, wherein the high-strength steel of the core substrate contains martensite, ferrite and bainite.

10. A sheet blank according to claim 1, wherein the high-strength steel of the core substrate contains martensite, ferrite and austenite.

11. A sheet blank according to claim 1, wherein the high-strength steel of the core substrate contains martensite, ferrite and retained austenite.

12. A sheet blank according to claim 1, wherein the high-strength steel of the core substrate contains less than 80 volume % ferrite.

13. A sheet blank according to claim 1, wherein each respective decarburized layer contains at least 85 volume % ferrite.

14. A sheet blank according to claim 1, wherein each respective decarburized layer contains at least 90 volume % ferrite.

15. A sheet blank, comprising:
a core substrate having a generally planar shape with opposed first and second sides, the core substrate being made of high-strength martensitic steel containing at least 95 volume % martensite and having an ultimate tensile strength of at least 900 MPa; and
a respective decarburized layer of the high-strength martensitic steel formed on each of the first and second sides of the core substrate, wherein each respective decarburized layer contains at least 80 volume % ferrite and has a respective thickness of 5 to 100 microns.

16. A sheet blank according to claim 15, wherein the high-strength martensitic steel of the core substrate contains up to 5 volume % of ferrite, bainite, austenite, or a combination of two or more of ferrite, bainite, and austenite.

17. A sheet blank, comprising:
a core substrate having a generally planar shape with opposed first and second sides, the core substrate being made of high-strength martensitic steel containing at least 95 volume % martensite and containing up to 5 volume % of ferrite, bainite, austenite, or a combination of two or more of ferrite, bainite, and austenite and having an ultimate tensile strength of at least 900 MPa; and
a respective decarburized layer of the high-strength martensitic steel formed on each of the first and second sides of the core substrate, wherein each respective decarburized layer contains a minimum ferrite content of at least 80 volume % ferrite and has a respective thickness of 5 to 100 microns.

18. A sheet blank according to claim 17, wherein a respective transition layer of the high-strength martensitic steel is formed between the core substrate and each respective decarburized layer, wherein the volume % ferrite in each respective transition layer varies from 0 to 5 volume % in a respective inner transition layer thereof that is disposed in contact with the core substrate up to the minimum ferrite content in a respective outer transition layer thereof that is disposed in contact with the respective decarburized layer.

19. A sheet blank according to claim 17, wherein the high-strength martensitic steel of the core substrate contains less than 5 volume % ferrite.

20. A sheet blank according to claim 17, wherein each respective decarburized layer contains at least 85 volume % ferrite.
